(19) United States
(12) Patent Application Publication
(10) Pub. No.: US 2019/0005134 A1
(43) Pub. Date: Jan. 3, 2019

(54) METHOD FOR IDENTIFYING EXTENSION MESSAGES OF VIDEO, AND IDENTIFICATION SYSTEM AND STORAGE MEDIA THEREOF

(71) Applicant: Viscovery (Cayman) Holding Company Limited, Grand Cayman (KY)

(72) Inventors: Yun-Fu LIU, Taipei City (TW); Shao-Hang HSIEH, Taipei City (TW); Chun-Chieh HUANG, Taipei City (TW)

(21) Appl. No.: 15/726,940

(22) Filed: Oct. 6, 2017

(30) Foreign Application Priority Data
Jun. 30, 2017 (CN) 201710526049.4

(51) Int. Cl. G06F 17/30; G06Q 30/02; G06N 5/04

(52) U.S. Cl. CPC G06F 17/30858; G06N 5/04; G06Q 30/0251; G06F 17/3082

(57) ABSTRACT

A method for identifying extension messages of a video includes: providing a video; converting content of the video into a content list including a plurality of descriptor lists, each descriptor list recording a time interval and raw descriptors for describing a feature presented in the video at the time interval; providing a descriptor semantic model (DSM) including a plurality of node descriptors and a plurality of directed edges wherein each node descriptor corresponds to a predetermined feature, and the directed edges define relation strengths among the node descriptors; importing the raw descriptors of the descriptor list into the DSM to update the raw descriptors as refined descriptors and to obtain one or more inferred descriptors; and updating the descriptor lists based on the refined descriptors and the inferred descriptors. An identification system and storage media thereof are also provided.

### BACKGROUND OF THE INVENTION

### 1. Technical Field

The technical field relates to identification methods of videos, and identification systems and storage media thereof, and more particularly relates to a method for identifying extension messages of a video, and identification system and storage media thereof.

### 2. Description of Related Art

Advertising is the best form of marketing communication that employs an openly sponsored message to promote or sell a product or service. On-line advertising on a computer network (e.g., the Internet) has been competitive in recent years. Specifically, in addition to advertising on the website through messages and/or pictures, an advertiser/advertising agency (refers as advertiser hereinafter) may also use videos to promote or sell a product or service.

Prior to publishing an advertisement, an advertiser may hire staffs for studying the content of the video to determine whether it is appropriate to insert an advertisement to make sure the advertisement is related to the content of the video in order to increase the effectiveness of the advertisement among general consumers. However, visually identifying the content of a video by human takes a lot of labor hours thus it is cost prohibitive. Therefore, automatic identification technologies that can automatically identify features (e.g., constituent colors, persons, objects, etc.) of a video are developed and commercially available. The automatic identification technologies are able to determine the category of the advertisement to be inserted in the video based on the identified features.

However, the conventional automatic identification technologies can only identify significant features of a video which are used to match with the significant features of an advertisement but fail to identify abstract messages such as emotions, states, conditions, extended messages of the video (e.g. identifying the features of “Trump” and “President of US” when a video shows “Trump”). Therefore, the advertiser using the conventional automatic identification technologies may lose many opportunities of advertising due to incapability of identifying valuable messages within a video.

Further, the conventional automatic identification technologies cannot correct erroneously identified significant features of a video, which may lead to erroneously publishing a product or service and render a negative effect to the perception of the audience about the product or service advertised on the shot. As a result, a great amount of money spent on the advertisement is wasted while the effectiveness of the advertisement is undesirable.

For example, the conventional automatic identification technologies may determine that an advertisement of luggage is appropriate to be inserted in the video because a piece of luggage is identified within the video. As a result, a video for promoting the sale of luggage is shown in the shot. However, the scene of the video is a kitchen so the irrelevance between the video and the advertisement material failed to create a connection between the audiences and the product. The purpose of promoting the sale of luggage among the general consumers is not achieved.

Thus, there is a need for improvements on how the computer or artificial intelligence can depict the images/videos like or getting closer to human.

### SUMMARY OF THE INVENTION

One of the objectives of the invention is to provide a method for identifying extension messages of a video by identifying significant features of the video so that the extension messages of the video can be inferred from the identified significant features to depict the content of the video. Thus, the content of the video can be interpreted like human based on the significant features and the extension messages.

One embodiment of the present invention is directed to a method for identifying extension messages of video, comprising the steps of: (a) providing a video; (b) converting content of the video into a content list including a plurality of descriptor lists, each of the descriptor lists recording a time interval and a raw descriptor for describing a feature presented in the video at the time interval; (c) providing a descriptor semantic model (DSM) including a plurality of node descriptors and a plurality of directed edges, wherein each node descriptor corresponds to a predetermined feature, and the directed edges define relation strengths among the node descriptors; (d) importing one of the descriptor lists of the content list into the DSM, wherein the node descriptors include the raw descriptors; (e) inferring an inferred descriptor from the node descriptors following step (d), the inferred descriptor having a relation with the raw descriptors; and (f) adding the inferred descriptor to the inputted descriptor list to update the descriptor list.

Another embodiment of the present invention is directed to a system for identifying extension messages of video, comprising: a video conversion module for selecting a video and converting content of the selected video into a content list, wherein the content list includes a plurality of descriptor lists, each descriptor list recording a time interval and a raw descriptor for describing a feature of the video presented in the time interval; a descriptor relation learning module for training and creating a descriptor semantic model (DSM) by using a plurality of datasets, wherein the DSM includes a plurality of node descriptors corresponding to a plurality of predetermined features respectively, and a plurality of directed edges, each defining a relational strength between two of the node descriptors; and an inference module for importing one of the descriptor lists of the content list into the DSM, wherein the node descriptors include the raw descriptors, the inference module obtains an inferred descriptor related to the raw descriptors from the node descriptors, and adds the inferred descriptor to the imported descriptor list for updating the descriptor list.

Another embodiment of the present invention is directed to a non-transitory storage media for storing a program which, when executed by a processing unit, performs operations comprising: providing a video; converting content of the video into a content list including a plurality of descriptor lists, each descriptor list recording a time interval and a raw descriptor for describing a feature presented in the video at the time interval; providing a descriptor semantic model (DSM) including a plurality of node descriptors and a plurality of directed edges, wherein each node descriptor corresponds to a predetermined feature, and the directed edges define relation strengths among the node descriptors; inputting one of the pluralities of descriptor lists of the content list into the DSM, wherein the node descriptors include the raw descriptors; inferring an inferred descriptor from the node descriptors, the inferred descriptor having a relation with the raw descriptors; refining the raw descriptors based on the directed edges corresponding to the raw descriptors in the DSM for converting the raw descriptors into a plurality of refined descriptors, wherein a number of the refined descriptors is equal to or less than a number of the raw descriptors; and updating the descriptor list based on the inferred descriptors and the refined descriptors.

The invention has the following advantages and benefits in comparison with the conventional art: content of the video shown in the shot can be interpreted correctly based on the significant features and the extension messages identified by computer vision. A shot of a video having the highest relational index with an advertisement can be selected for inserting, thereby increasing effectiveness of the advertisement, wherein there is no restriction to the format of the advertisement. Moreover, one or more significant features detected by the identification system of the invention can be refined to correct erroneous features detected by the identification system, thereby greatly increases detection accuracy.

The above and other objectives, features and advantages of the invention will become apparent from the following detailed description taken with the accompanying drawings.

### BRIEF DESCRIPTION OF THE DRAWINGS

FIG. 1 is a block diagram of an identification system according to a first preferred embodiment of the invention;

FIG. 2 schematically depicts a content list of the first preferred embodiment of the invention;

FIG. 3 is a flowchart of a method for identifying extension messages of a video according to the first preferred embodiment of the invention;

FIG. 4 schematically depicts a descriptor semantics model of the first preferred embodiment of the invention;

FIG. 5A schematically depicts first identification action of the first preferred embodiment of the invention;

FIG. 5B schematically depicts second identification action of the first preferred embodiment of the invention;

FIG. 5C schematically depicts third identification action of the first preferred embodiment of the invention;

FIG. 5D schematically depicts fourth identification action of the first preferred embodiment of the invention;

FIG. 6 is a flowchart of the generation of the content list of the first preferred embodiment of the invention;

FIG. 7 schematically depicts the generation of the descriptors of the first preferred embodiment of the invention;

FIG. 8 is a flowchart of an advertisement category analysis of the first preferred embodiment of the invention;

FIG. 9 is a flowchart of recommending places for advertisements of the first preferred embodiment of the invention; and

FIG. 10 is a block diagram of an identification system according to a second preferred embodiment of the invention.

### DETAILED DESCRIPTION OF THE INVENTION

Embodiments of the invention will now be described, by way of example only, with reference to the accompanying drawings.

A system for identifying extension messages of a video is disclosed by the invention (called the identification system hereinafter). The identification system can analyze an imported video to identify significant features of the video, and further identify abstract and extension messages of the video. Consequently, when analyzing a shot of a video to insert an advertisement, the significant features and the extension messages are provided for the analysis so the accuracy is greatly improved. For the sake of helping ordinary artisans of the art to understand the invention, a descriptor (or a tag) will be used to represent a significant feature which but is not limited to such.

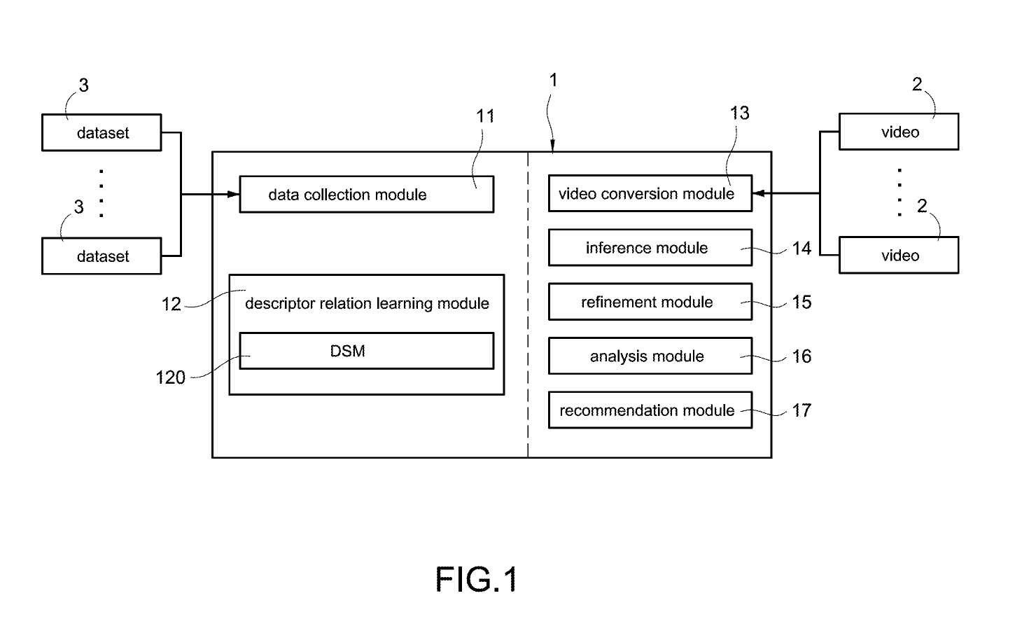

Referring to FIG. 1, a block diagram of an identification system 1 in accordance with a first preferred embodiment of the invention is shown. In the embodiment of FIG. 1, the identification system 1 includes a data collection module 11, a descriptor relation learning module 12, a video conversion module 13, an inference module 14, a refinement module 15, an analysis module 16 and a recommendation module 17. In the embodiment, the data collection module 11 and the descriptor relation learning module 12 belong to an offline section of the identification system 1, and the video conversion module 13, the inference module 14, the refinement module 15, the analysis module 16 and the recommendation module 17 belong to an online section of the identification system 1.

In the identification system 1 of the embodiment, a descriptor semantic model (DSM) 120 is trained in the offline section and the DSM 120 is regularly updated (as discussed later). A user is not allowed to communicate with the offline section. The identification system 1 receives or selects a video 2 and an advertisement (not shown) to be analyzed by the user by enabling the online section. Thus, the identification system 1 can determine which shot of the video 2 is appropriate for the advertisement by matching the significant and abstract features of the advertisement with the significant and abstract features of the shot, or determine whether an advertisement is appropriate for a specific shot of the video 2. In other embodiments, the identification system 1 may not be categorized into online and offline sections, all modules are in the online section so the DSM 120 is updated online.

It is noted that in one embodiment as shown in FIG. 1, the identification system 1 is a server (e.g., local server or cloud server), and the modules 11 to 17 are hardware units of the server so as to perform different functions. In another embodiment as shown in FIG. 1, the identification system 1 is a single process or an electronic apparatus. The identification system 1 can run a specific program to perform different functions of the invention. The modules 11 to 17 correspond to the different functions performed by the specific program respectively.

The data collection module 11 is adapted to access the Internet for collecting public data from a plurality of datasets 3. Specifically, the dataset 3 is encyclopedia, textbook, information from Wikipedia, network news, or network commentaries such as opinions on YouTube or opinions on Facebook which are updated as time revolves. Data stored in the dataset 3 can be and not limited to texts, pictures, videos and audios.

The data collection module 11 collects updated data from the datasets 3 in real time or collects updated data from the datasets 3 by using Crawler to access the Internet regularly. Further, data from the datasets 3 is inputted to the descriptor relation learning module 12. And in turn, the descriptor relation learning module 12 analyzes the data to train and output the DSM 120.

The descriptor relation learning module 12 uses data inputted from the datasets 3 to train the DSM 120. In one embodiment, the descriptor relation learning module 12 analyzes the inputted datasets 3 by using deep learning or artificial intelligence (AI) so as to obtain the relations among features (such as above texts, pictures and videos) and descriptors. Further, the descriptor relation learning module 12 obtains core meaning of the descriptors, and uses Hidden Markov Model algorithms to train the DSM 120. The purpose of obtaining the core meaning is to make the descriptors more consistent and reduce data redundancy. The descriptor relation learning module 12 may simplify terms and replace a plural form of a term with a singular form thereof. For example, the words “happy” and “happiness” are considered as “happy”, and words “book” and “books” are considered as “book” in the sematic space respectively.

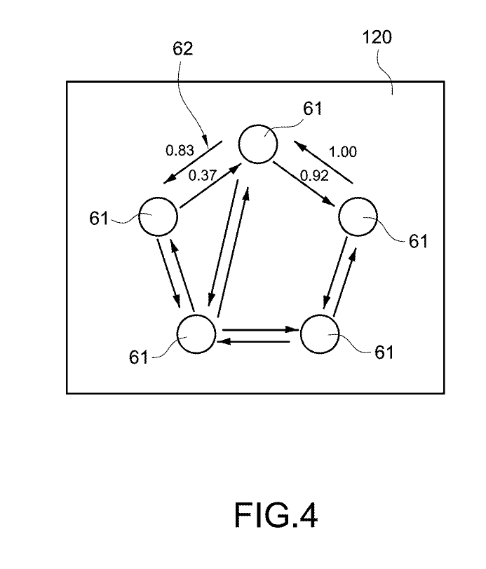

Specifically, the DSM 120 is comprised of a plurality of node descriptors such as node descriptors 61, and a plurality of directed edges such as directed edges 62 of FIG. 4. The node descriptors 61 correspond to a plurality of predetermined features respectively, and each of the directed edges 62 defines a relational strength between two node descriptors 61.

In one embodiment, the number of the node descriptors 61 is thousands, ten thousands, or more. The node descriptors 61 comprise various features including and not limited to persons (e.g., Donald Trump and Michael Jordan), objects (e.g., cars, tables, cats, and dogs), actions (e.g., eating, drinking, lying, and running), emotions (e.g., happy and angry), mental states (e.g., easy, tense, and opposing), and titles (e.g., president and manager). Each of the directed edges 62 defines a relational strength between two node descriptors, i.e., two features such as a relational strength between Donald Trump and president, and a relational strength between eating and happy.

The video conversion module 13 functions to receive one of a plurality of videos 2 or select one of the videos 2 for analysis. Content of the received or selected video 2 is converted into a content list by the video conversion module 13. In the invention, the identification system 1 determines whether an advertisement is related to the content of the video 2 based on the content list.

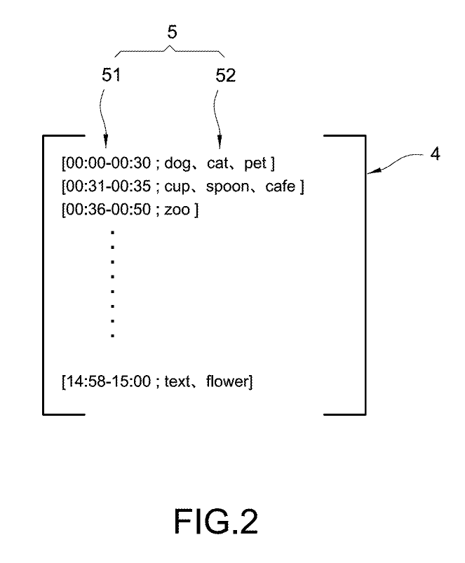

Referring to FIG. 2, it schematically depicts a content list of the first preferred embodiment of the invention. As shown, the video conversion module 13 generates a content list 4 for each video 2. The content list 4 includes a plurality of descriptor lists 5 and each descriptor lists 5 records a time interval 51 and one or more raw descriptors 52.

Specifically, the plurality of time intervals 51 is not overlapped. As shown in FIG. 2, the plurality of time intervals 51 include [0000-00:30], . . . , [00:31-0035], and [00:36-0050], each raw descriptors 52 respectively describes one or more features of the video 2 presented in a corresponding time interval 51. For example, features of dog, cat and pet of the video 2 present in the time interval [00:00-00:30], and features of cup, spoon and cafeteria of the video present in the time interval [00:30:00:35]. In other words, in response to analysis by the video conversion module 13, the identification system 1 initially identifies significant features of the video 2. The significant features are recorded as the raw descriptors 52 respectively. Further, time of each significant feature presented in the video 2 is recorded in the time interval 51.

The video conversion module 13 can identify and not limit to face, image, text, audio, action, object and scene as the significant features.

However, the video conversion module 13 cannot identify extension messages of the video 2. For example, the video conversion module 13 cannot obtain a descriptor representing “US President” after identifying a descriptor representing “Trump”. In a further example, the video conversion module 13 cannot obtain a descriptor representing “dangerous” or “urgent” after identifying a descriptor representing “a man pointing a gun toward another person”.

As described above, for further identifying the extension messages of the video 2, the identification system 1 of the invention provides the inference module 14 and the DSM 120 that is trained either online or offline.

After the video conversion module 13 finishes analysis, the inference module 14 imports one or all descriptor lists 5 of the content list 4 of the video 2 into the DSM 120. For the sake of simplicity, an example of the inference module 14 importing one descriptor list 5 of the content list 4 into the DSM 120 will be discussed in detail.

In the embodiment, the number of the node descriptors 61 in the DSM 120 is enormous. The node descriptors 61 include all raw descriptors 52 recorded in the imported descriptor lists 5. In the invention, the inference module 14 obtains one or more inferred descriptors related to the raw descriptors 52 from the node descriptors 61 in the DSM 120. The inferred descriptors are added to the descriptor lists 5 for updating the descriptor lists 5. Thus, the identification system 1 can increase the number of descriptors in the descriptor lists 5 and the descriptors are used for reference and analysis purposes.

Specifically, the inference module 14 obtains one or more of the node descriptors 61 related to the raw descriptors 52 based on the directed edges 62 related to the raw descriptors 52 and considers the obtained node descriptors 61 as the inferred descriptors. Generally speaking, features corresponded by the inferred descriptors are extension messages (e.g., descriptors representing “US President”, “dangerous”, and “urgent” as described above) that cannot be identified by the video conversion module 13.

In one embodiment, the inference module 14 calculates an index (i.e., relational index) of each raw descriptor 52 related to other node descriptors 61 based on the directed edges 62 related to the raw descriptors 52. One or more node descriptors having the highest relational index is(are) taken as the inferred descriptor(s). In the invention, the relational index means when there is a raw descriptor A, the probability of a node descriptor B exists. Hence, the higher the relational index the higher the probability that the inference module 14 sets the node descriptor B as the inference index. In the embodiment, if the number of the node descriptors 61 related to each raw descriptor 52 is large (e.g., 5,000), the inference module 14 takes a plurality of (e.g., five or ten) node descriptors 61 having the highest relational index as the inferred descriptor.

In another embodiment, the inference module 14 calculates index (i.e., relational index) of each raw descriptor 52 related to other node descriptors 61 based on the directed edges 62 related to the raw descriptors 52. One or more node descriptors having a relational index higher than a threshold value is(are) taken as the inferred descriptor(s). For example, if the number of the node descriptor 61 related to each raw descriptor 52 is large and the threshold value is 0.8, the inference module 14 takes a plurality of node descriptors 61 having a relational index higher than 0.8 as the inferred descriptor.

After using the inference module 14 and the DSM 120, the identification system 1 of the invention can further identify the extension messages of the video 2 and generate the inferred descriptor which is in turn added to the descriptor lists 5 for increasing the number of descriptors in the descriptor lists 5. For example, descriptors representing “dog”, “cat” and “pet” are identified in a scene/shot. The identification system 1 infers descriptors representing “pet food”, “lovely”, “fur” and “vacuum cleaner” by means of the inference module 14 and the DSM 120. In such a manner, when a video publisher needs to find out the additional kinds of advertisement that is related to the content of the video or an advertiser needs to find out which video is suitable for inserting the advertisement with specific content, a more accurate analysis can be obtained and the number of suitable advertisements that could be inserted can be increased.

It is noted that after the inference module 14 updates the descriptor lists 5, the identification system 1 of the invention may import the updated descriptor lists 5 into the DSM 120 again so as to find the inferred descriptor and update the descriptor lists 5 until the content of the descriptor lists 5 is not changed any more. Thus, it is possible to ensure a relationship of the obtained inferred descriptors and the raw descriptors 52.

In the invention, the video conversion module 13 identifies the video 2 to obtain significant features of the video 2 and generates the raw descriptors 52 by using conventional identification technologies such as Convolution Neural Network (CNN). But the accuracy of the conventional identification technologies is not 100%. Thus, the raw descriptors 52 may erroneously represent wrong features. For example, a refrigerator is erroneously identified as a luggage. For solving the problem by correcting or eliminating the erroneous descriptors, the identification system 1 of the invention further comprises the refinement module 15.

The refinement module 15 imports a descriptor list 5 of the content list 4 into the DSM 120 and refines a plurality of raw descriptors 52 based on the directed edges 62 in the DSM 120 that corresponds to the raw descriptors 52. As a result, parts of the raw descriptors 52 are converted into refined descriptors. And in turn, the refinement module 15 updates the raw descriptors 52 of the descriptor lists 5 based on the refined descriptors. In one embodiment, the number of the refined descriptors is equal to or less than that of the raw descriptors 52 of the descriptor lists 5 before the updating.

In the invention, the refinement module 15 determines the relation among the raw descriptors 52 of the descriptor lists 5 based on the DSM 120. If the relations between a specific raw descriptor 52 and other raw descriptors 52 are too low, the refinement module 15 determines the specific raw descriptors 52 is erroneous. The erroneous descriptor is corrected as a refined descriptor or being eliminated.

For example, if the descriptor lists 5 include raw descriptors 52 representing “luggage”, “kitchen”, “pan”, “bottle” and “water tank”, the refinement module 15 determines that the relations between the raw descriptor 52 representing “luggage” and other raw descriptors 52 are too low based on the directed edges 62 corresponding to the raw descriptor 52 representing “luggage”. And in turn, the raw descriptor 52 presenting “luggage” is eliminated. Further, the refinement module 15 determines that the relations between one node descriptor 61 representing “refrigerator” (e.g., the inferred descriptor) and other raw descriptors 52 are very high. Further, the refinement module 15 determines that the video conversion module 13 erroneously identifies “refrigerator” as “luggage” and subsequently corrects the descriptor as one representing “refrigerator”. But precedent example only describes a preferred embodiment of the invention and the invention is not limited to the example set forth above.

In one embodiment, the refinement module 15 calculates index (i.e., relational index) among the raw descriptors 52 based on the directed edges 62 related to the raw descriptors 52. One or more raw descriptors 52 having the highest relational index is(are) taken as the refined descriptor(s). For example, the descriptors having the highest relational index are taken as the refined descriptors. As a result, the descriptor lists 5 are updated. In another embodiment, one or more raw descriptors 52 having a relational index higher than a threshold value is (are) taken as the refined descriptor(s) by the refinement module 15. As a result, the descriptor lists 5 are updated.

It is noted that the inference module 14 and the refinement module 15 may be enabled simultaneously to generate the inferred descriptor(s) and the refined descriptor(s). In other words, the inferred descriptor(s) and the refined descriptor(s) may be generated simultaneously rather than in a fixed sequence.

Specifically, the inference module 14 may fetch a plurality of inferred descriptors related to the raw descriptors 52 from a plurality of node descriptors 61 in the DSM 120 prior to the generation of refined descriptors. Alternatively, the inference module 14 may fetch a plurality of inferred descriptors related to the refined raw descriptors from a plurality of node descriptors 61 after the generation of refined descriptors. Further, the refinement module 15 may refine a plurality of raw descriptors 52 based on the raw descriptors 52 and related directed edges 62 prior to the generation of inferred descriptors. Alternatively, the refinement module 15 may refine a plurality of raw descriptors 52 and inferred descriptors based on the raw descriptors 52, the inferred descriptors and related directed edges 62 after the generation of inferred descriptors.

As described above, the video conversion module 13 converts the video 2 into the content list 4 by using conventional identification technologies such as CNN. In the invention, after the refinement module 15 generating the refined descriptors (i.e., amending or eliminating the raw descriptors 52), the identification system 1 makes use of the refined descriptors to train the CNN online or offline. In such a manner, the longer the time of using the identification system 1, the more accurate the identification of the video conversion module 13 will be. Further, less raw descriptors are erroneously identified.

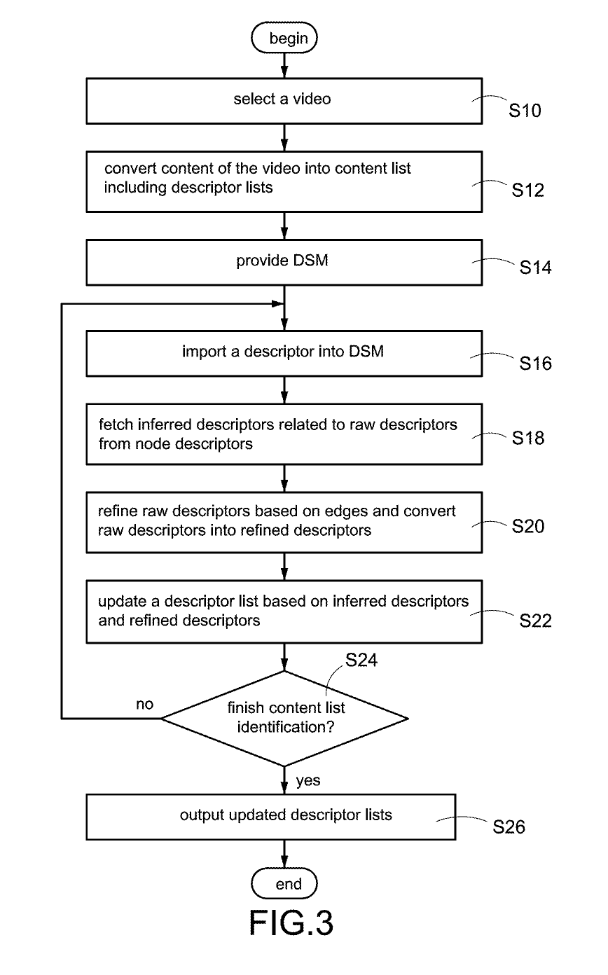

Referring to FIG. 3, it is a flowchart of an identification method according to the first preferred embodiment of the invention. The invention further discloses a method for identifying extension messages of a video (called identification method hereinafter). The identification method is performed by the identification system 1 shown in FIG. 1.

As illustrated in FIG. 3, for performing the identification method of the invention, the identification system 1 first provides or selects a video 2 (step S10). Next, the video conversion module 13 converts the video 2 into a content list 4 having a plurality of descriptor lists 5 (step S12). As shown in FIG. 2, each descriptor list 5 records a time interval 51 and one or more raw descriptors 52. Each raw descriptor 52 depicts a feature of the video 2 presented in a corresponding time interval 51.

Next, the descriptor relation learning module 12 provides the trained DSM 120 (step S14) in which the DSM 120 is comprised of a plurality of node descriptors 61 and a plurality of directed edges 61. As described above, each of the node descriptors 61 corresponds to a predetermined feature and the directed edges 62 correspond to relational strengths among the node descriptors 61.

Next, the identification system 1 imports at least one descriptor list 5 of the content list 4 into the DSM 120 (step S16) in which the plurality of node descriptors 61 include all raw descriptors 52 recorded in the at least one descriptor list 5 imported by the identification system 1.

Next, the inference module 14 fetches a plurality of inferred descriptors related to the raw descriptors 52 from the node descriptors 61 (step S18), and updates the imported descriptor lists 5 based on the inferred descriptors.

Further, if the identification system 1 has the refinement module 15, the refinement module 15 refines the plurality of raw descriptors 52 based on the directed edges 62 in the DSM 120 related to the plurality of raw descriptors 52 so as to convert the raw descriptors 52 into a plurality of refined descriptors (step S20), and the refinement module 15 may update the imported descriptor lists 5 based on the refined descriptors.

Specifically, the sequence of performing steps S18 and S20 is not fixed, that is, the identification system 1 may selectively perform step S18 (or step S20), or perform step S18 and S20 simultaneously. Further, after performing steps S18 and S20, the identification system 1 updates the descriptor lists 5 through adding the inferred descriptors to the imported descriptor lists 5 and updating the plurality of raw descriptors 52 in the imported descriptor lists 5 based on the refined descriptors (step S22).

Specifically, in one embodiment, the identification system 1 repeatedly performs steps S18 to S22 for continuing the generation of inferred descriptors and refined descriptors and continuing the update of the descriptor lists 5 until content of the descriptor lists 5 is no longer changed. Therefore, it is possible of ensuring the relationship of the inferred descriptors and the raw descriptors 52 as well as improving the accuracy of the raw descriptors 52.

In step S18, the inference module 14 calculates index (i.e., relational index) of the raw descriptors related to other node descriptors 61 based on the directed edges 62 related to the raw descriptors 52. One or more node descriptors 61 having the highest relational index may be taken as the inferred descriptor(s). Alternatively, one or more node descriptors with a relational index higher than a threshold value may be taken as the inferred descriptor(s). Further, in step S20, the refinement module 15 calculates a relational index showing the relation among the raw descriptors 52 based on the directed edges 62 related to the raw descriptors 52. The refinement module 15 may take one or more raw descriptors 52 having the highest relational index as the refined descriptor(s). Alternatively, the refinement module 15 may take one or more raw descriptors 52 having a relational index higher than a threshold value as the refined descriptor(s).

It is noted that in step S18, the inference module 14 may fetch a plurality of inferred descriptors related to the raw descriptors 52 from the node descriptors 61. Alternatively, the inference module 14 may fetch a plurality of inferred descriptors related to the refined descriptors from the node descriptors 61. In step S20, the refinement module 15 may refine a plurality of raw descriptors 52 based on the raw descriptors 52 and related directed edges 62. Alternatively, the refinement module 15 may refine a plurality of raw descriptors 52 based on the raw descriptors 52, the inferred descriptors and related directed edges 62.

After step S22, the identification system 1 further determines whether the content list 4 has been identified or not (step S24). Specifically, in step S16, the identification system 1 imports only one descriptor list 5 of the content list 4 into the DSM 120. Steps S18 to S22 are performed to identify the imported descriptor list 5. In response to the determination of the content list 4 has not been completely identified in step S24, the identification system 1 returns to step S16. In step S16, the identification system 1 imports the next descriptor list 5 of the content list 4 into the DSM 120. Steps S18 to S22 are performed until all descriptor lists 5 of the content list 4 have been identified and updated.

In other embodiments, however, the identification system 1 may import all descriptor lists 5 of the content list 4 into the DSM 120 in step S16 as well as identify and update the descriptor lists 5 in the same time. In one embodiment, step S24 is omitted.

In response to the determination of the content list 4 has been completely identified in step S24, the identification system 1 outputs the updated descriptor lists 5 (step S26). Therefore, when the identification system 1 analyzes the content of each shot of the video 2 to determine what kind of advertisement is appropriate to be inserted, or analyzes a specific advertisement to determine which shot of the video 2 is appropriate for the specific advertisement, the updated content list 4 can be used for analysis. The updated content list 4 has more accurate descriptors (e.g., the refined descriptors) and descriptors (e.g., the inferred descriptors) with subtle, abstract and extended information. Thus, the identification system 1 can obtain a more accurate analysis result by using the identification method of the invention.

Referring to FIG. 4, it schematically depicts a DSM of the first preferred embodiment of the invention. As shown in FIG. 4, the DSM 102 includes a plurality of node descriptors 61 and a plurality of directed edges 62 in which the node descriptors 61 correspond to a plurality of (e.g., thousands or ten thousands) predetermined features respectively, and each directed edge 62 defines a relational strength between any two adjacent node descriptors 61. For example, values 0.83, 0.37, 1.00 and 0.92 are shown in FIG. 4 in which the greater of the value the stronger of the relational strength is.

The identification system 1 can understand a relation between a descriptor A and a descriptor B in view of the description of the DSM 120. In other words, after referencing to DSM 120, the identification system 1 understands the probability of the existence of the descriptor B with respect to the existence of descriptor A, and the probability of the existence of the descriptor A with respect to the existence of descriptor B. It is noted that the relational strength of descriptor A to descriptor B may be different from the relational strength of descriptor B to descriptor A.

For example, a relational strength between the descriptor “Michael Jordan” and the descriptor “President” is 0.05 because there is a news report that Michael Jordan met with US President. This means when the descriptor “Michael Jordan” exists, the probability of the co-existence of the descriptor “President” is very low. In another example, a relational strength between the descriptor “Donald Trump” and the descriptor “President” is 0.95 because the incumbent President of the United States is Donald Trump. This means when the descriptor “Donald Trump” exists, the probability of the co-existence of the descriptor “President” is very high.

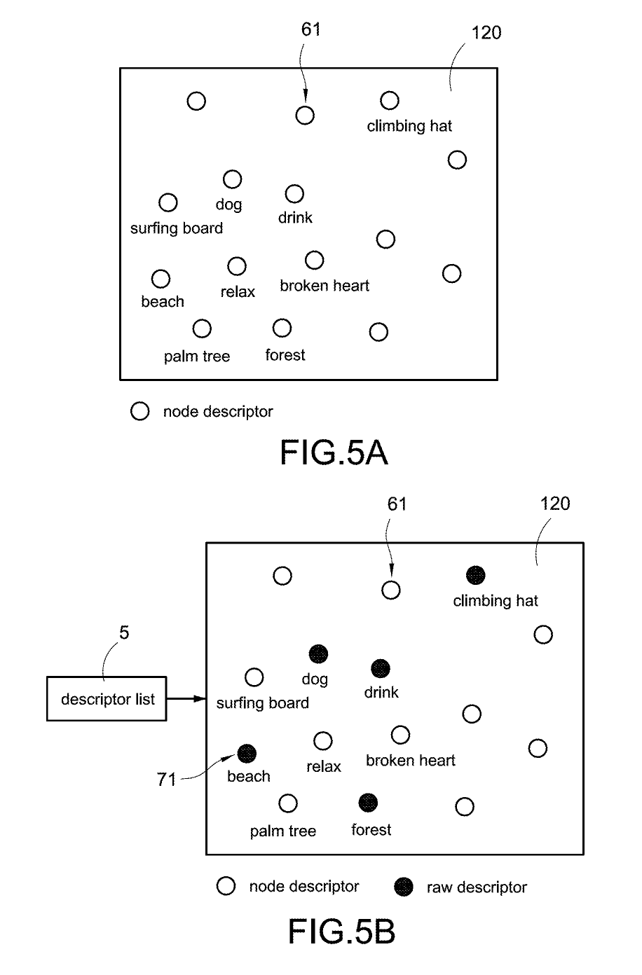

Referring to FIGS. 5A to 5D, they schematically depict first to fourth identification actions of the first preferred embodiment of the invention and discuss steps S14 to S20 of FIG. 3 by means of an exemplary example.

First, as shown in FIG. 5A, the identification system 1 provides a trained DSM 120. In the embodiment, the DSM 120 comprises the node descriptors 61 including “climbing hat”, “dog”, “surfing board”, “beach”, “drink”, “relax”, “broken heart”, “palm tree” and “forest”. For simplicity, in the embodiment of FIGS. 5A to 5D the directed edges 62 in the DSM 120 are eliminated.

Next, as shown in FIG. 5B, the identification system 1 imports a descriptor list 5 into the DSM 120. In the embodiment, the descriptor list 5 comprises raw descriptors 71 including “climbing hat”, “dog”, “drink”, “beach” and “forest”. The identification system 1 converts corresponding descriptors in the DSM 120 into the raw descriptors 71.

Next, as shown in FIG. 5C, if the refinement module 15 exists in the identification system 1, after finishing the refinement (i.e., performing step S20 of the embodiment in FIG. 3) the refinement module 15 determines that a relational strength between the descriptor “climbing hat” and any of other raw descriptors 71 is very low. And in turn, the refinement module 15 determines that “climbing hat” is identified erroneously. Further, the refinement module 15 returns the descriptor “climbing hat” to be one of the node descriptors 61 and converts the remaining raw descriptors 71 into refined descriptors 72.

Next, as shown in FIG. 5D, the inference module 14 of the identification system 1, after finishing the inference (i.e., performing step S18 of the embodiment in FIG. 3), it is determined that the descriptors “surfing board”, “palm tree” and “relax” are descriptors having a high relational strength with the raw descriptors 71 (or the refined descriptors 72). And in turn, the inference module 14 sets the descriptors as inferred descriptors 73.

After finishing the above actions, the identification system 1 adds the generated inferred descriptors 73 to the descriptor list 5 and updates the raw descriptors 71 of the descriptor list 5 based on the refined descriptors 72. Thus, when the identification system 1 analyzes the video 2 based on the updated descriptor list 5, a more accurate analysis can be obtained.

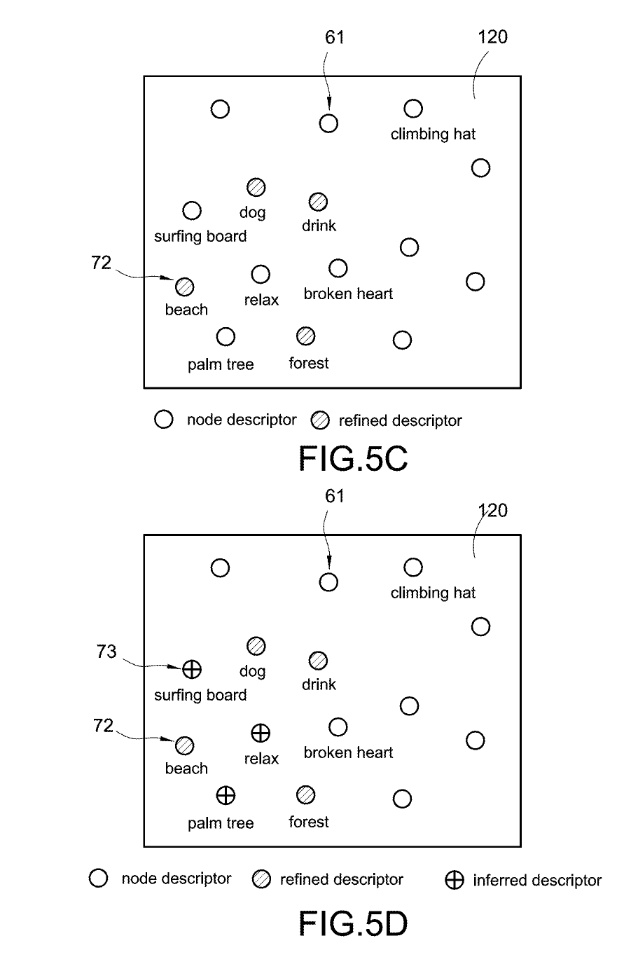

Referring to FIG. 6 in conjunction with FIG. 2, FIG. 6 is a flowchart of the generation of the content list according to the first preferred embodiment of the invention. Step S12 of the embodiment in FIG. 3 is further described by referring to FIG. 6 in which the video conversion module 13 converts content of the video 2 into the content list 4.

Specifically, when the identification system 1 receives or selects a video 2, the video conversion module 13 divides the video 2 into a plurality of shots (step S30). More specifically, the video conversion module 13 divides the video 2 based on the predetermined time unit. In the embodiment, the time unit is (but is not limited to) the time interval 51 shown in FIG. 2.

In a first embodiment, the video conversion module 13 may divide the video 2 into a plurality of shots in according to a predetermined time length (e.g., 3 seconds, 10 seconds, etc.). Each divided shot has the same time length corresponding to the predetermined time length.

In a second preferred embodiment, the video conversion module 13 can detect a scene change of the video 2 and divide the video 2 into a plurality of shots based on the scene change (i.e., each shot corresponds to a scene of the video 2). A detailed description of the scene change is omitted herein for the sake of brevity because its technologies are well known in the art.

In a third preferred embodiment, the video conversion module 13 may divide the video 2 into a plurality of shots frame-by-frame (i.e., the time length of each shot is according to a frame). The three embodiments of the invention above are set as the non-limiting examples to show there is no restriction on how the video conversion module 13 of the invention divides the video 2 into time segments.

After step S30, the video conversion module 13 further analyzes one of the shots to identify one or more features of the shot (step S32). And in turn, a raw descriptor 52 corresponding to the one or more features is created (step S34). The video conversion module 13 creates ten descriptors 52 if there are ten features within the shot.

Subsequently, the video conversion module 13 creates a descriptor list 5 based on the raw descriptors 52 of the shot and the time interval 51 corresponding to the shot (step S36).

As shown in FIG. 2, the video conversion module 13 identifies “dog”, “cat” and “pet” in a first shot of the time interval [00:00-00:30] and creates three corresponding raw descriptors 52 for representing the three identified features. And in turn, the video conversion module 13 creates a descriptor list 5 of the first shot based on the time internal 51 and the three raw descriptors 52. In another example, the video conversion module 13 identifies “text” and “flower” in an n-th shot of the time interval [14:58-15:00] and creates two raw descriptors 52 for representing the two identified features. And in turn, the video conversion module 13 creates a descriptor list 5 of the n-th shot based on the time internal 51 and the two raw descriptors 52.

Subsequently, the video conversion module 13 determines whether the shots of the video 2 have been analyzed (step S38). If the shots of the video 2 have not been analyzed yet, the flowchart returns to step S32 to analyze the next shot of the video 2 in order to create a descriptor list 5 of the next shot.

In another embodiment, the video conversion module 13 analyzes all shots of the video 2 simultaneously to create descriptor lists 5 of all shots. In the embodiment, step S38 is omitted.

If the video conversion module 13 determines that the shots of the video 2 have been completely analyzed, the video conversion module 13 creates a content list 4 of the video 2 based on all created descriptor lists 5 (step S40). Then, a conversion of the content of the video 2 is finished.

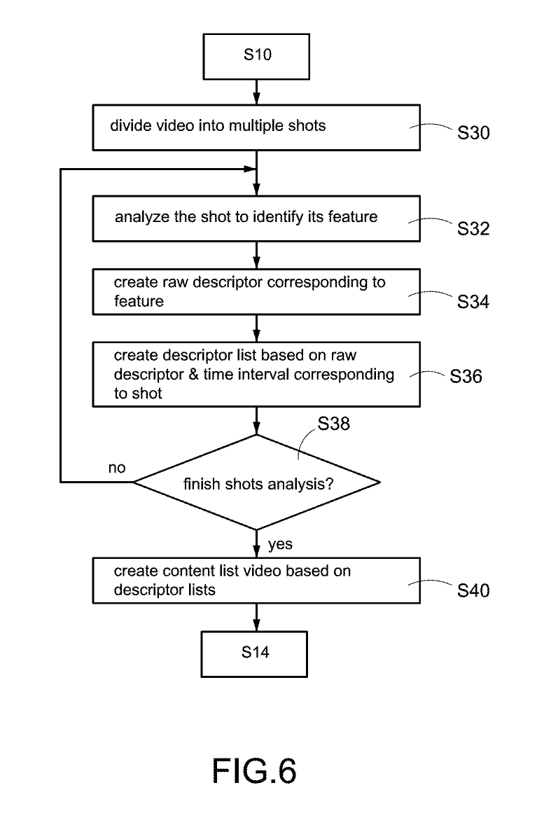

Referring to FIG. 7, it schematically depicts the generation of the descriptors of the first preferred embodiment of the invention. In brief, FIG. 7 is a flowchart illustrating that the identification system 1 and the identification method of the invention use a shot of a video to generate and update a descriptor list.

As shown in FIG. 7, when the identification system 1 identifies a shot 8, the identification system 1 obtains a plurality of raw descriptors 71 based on an analysis result of the video conversion module 13. For example, the raw descriptors 71 are representing “sunset”, “water”, “dawn”, “desk” and “boat” of FIG. 7. Further, as shown in FIG. 7, the video conversion module 13 calculates confidence value 710 of each raw descriptor 71. For example, the confidence value 710 of “sunset” is 0.997 and the confidence value 710 of “water” is 0.995.

Subsequently, the refinement module 15 processes the raw descriptors 71 and converts them into a plurality of refined descriptors 72. Further, the refinement module 15 calculates a relational index 720 of each of the refined descriptors 72 based on the directed edge 62 related to each of the raw descriptors 71.

As shown in the embodiment of FIG. 7, the refined descriptors 72 include a relational index 720 of “water” being 2.04293, a relational index 720 of “sky” being 1.365437, a relational index 720 of “sea” being 1.06653, a relational index 720 of “sunset” being 0.47669, etc. In the embodiment, the relational index 720 means a probability of the raw descriptor 71 and other raw descriptors 71 being co-existent in the shot 8. The relational indexes 720 are listed in a descending order from top to bottom to represent the refined descriptors 72. There is no restriction on the order on how the relational indexes 720 should be arranged.

It is noted that there are ten refined descriptors 72 in the embodiment of FIG. 7. According to the setting, the identification system 1 of the invention may update the raw descriptors 71 based on parts of the plurality of refined descriptors 72 having the highest relational index (e.g., the top five refined descriptors 72). Alternatively, the identification system 1 of the invention may update the raw descriptors 71 based on parts of the plurality of refined descriptors 72 having, and not limited to a relational index 720 greater than a threshold (e.g., 0.8).

At the same time, the inference module 14 processes the raw descriptors 71 to obtain a plurality of inferred descriptors 73 having a relation with the raw descriptors 71. Further, the inference module 14 calculates a relational index 730 of each inferred descriptor 73 based on the directed edge 62 related to each raw descriptor 71.

In the embodiment of FIG. 7, the inferred descriptors 73 include a relational index 730 of “nature” being 26.67924, a relational index 730 of “blue” being 21.02306, a relational index 730 of “outdoor” being 20.27564, a relational index 730 of “summer” being 20.25161, etc. In the embodiment, the relational index 730 means a probability of the raw descriptors 71 and the inferred descriptors 73 being co-existent in the shot 8. The relational indexes 730 are listed in a decreasing way from top to bottom to represent the inferred descriptors 73.

It is noted that there are ten inferred descriptors 73 in the embodiment of FIG. 7. According to the setting, the identification system 1 of the invention may add parts of the inferred descriptors 73 having the highest relational index to the descriptor list 5 of the shot 8. Alternatively, the identification system 1 of the invention may add parts of the inferred descriptors 73 having a relational index greater than a threshold to the descriptor list 5 of the shot 8 but is not limited thereto.

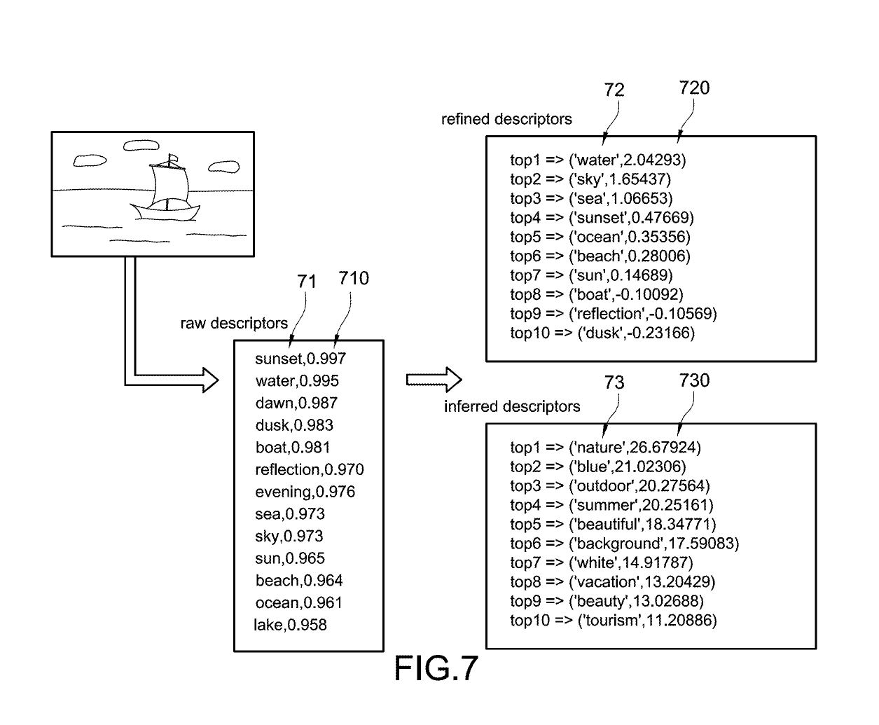

Referring to FIG. 8 in conjunction with FIG. 1, FIG. 8 is a flowchart of an advertisement category analysis of the first preferred embodiment of the invention. FIG. 8 illustrates how the identification system 1 of the invention determines each shot of a video may be appropriate for which ADC.

For performing above determination, the identification system 1 of the invention further comprises an analysis module 16 which is a physical unit or a programmed functional module and is not limited thereto.

Specifically, the identification system 1 selects one of a plurality of videos 2 to be analyzed (step S50). Next, the content list 4 of the selected video 2 is compared with criteria of multiple ADCs (step S52). In the embodiment, the criteria include related parameters of each ADC such as product description, type of product, objects presented in the advertisement, audience sexes, and audience ages and is not limited thereto.

After step S52, the analysis module 16 calculates a relational index for each shot of the video 2 with each ADCs (step S54). Further, the analysis module 16 shows one or more ADCs having a highest relational index for each shot, or one or more ADCs having a relational index greater than a threshold for each shot (step S56).

For example, if a video 2 is divided into three shots and the analysis module 16 compares the video 2 with three ADCs, the analysis module 16 calculates and obtains three relational indexes for each shot, wherein each of the relational indexes represents the relation between the shot and one of the three ADCs. In the embodiment, the greater of the relational index, the more appropriate of the shot is for the ADC to be published.

By taking advantages of the technical solutions illustrated in FIG. 8, the identification system 1 of the invention and the identification method thereof facilitate an owner of a video 2 to find the products or the ADCs that are appropriate to be published in each shot of the video 2. Thus, there is an increase of opportunities for the owner of the video 2 to find the sponsors.

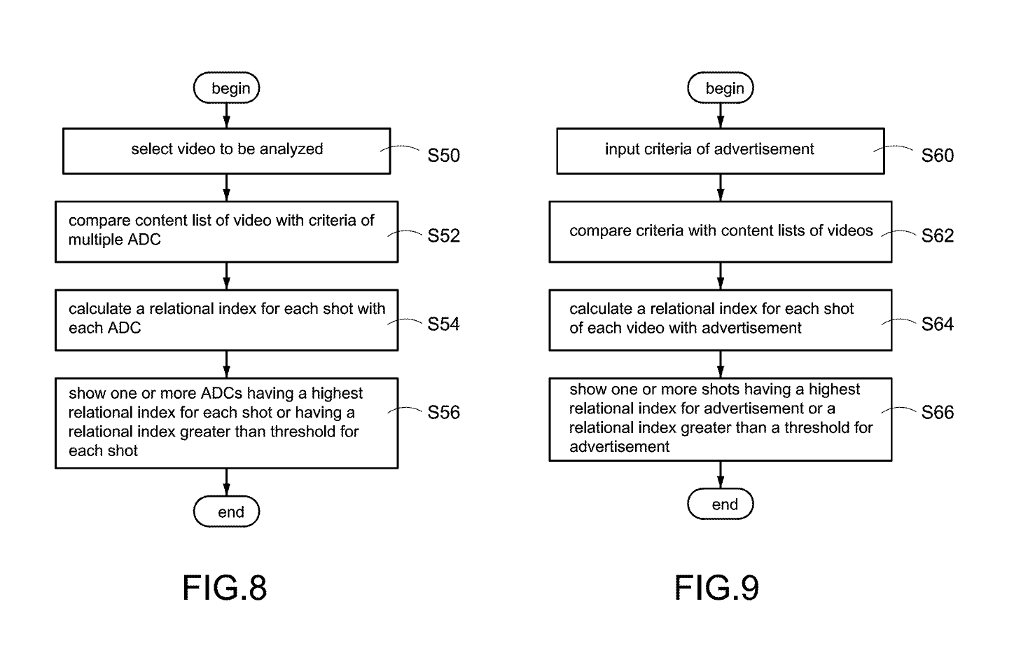

Referring to FIG. 9 in conjunction with FIG. 1, FIG. 9 is a flowchart of recommending places for placing advertisements of the first preferred embodiment of the invention. FIG. 9 illustrates how the identification system 1 of the invention determines a specific advertisement is appropriate for which shot of which video 2.

For performing aforementioned determination, the identification system 1 of the invention further comprises a recommendation module 17 which is a physical unit or a programmed functional module and is not limited thereto.

Specifically, the identification system 1 inputs criteria of an advertisement to be analyzed (step S60). Next, the criteria are compared with the content list 4 of each of the videos 2 (step S62). In the embodiment, the criteria include related parameters of the analyzed advertisement such as product description, type of product, objects presented in the advertisement, image properties, audience sexes, and audience ages and are not limited thereto.

After step S62, the recommendation module 17 calculates a relational index of the advertisement and each shot of each video 2 (step S64). Further, the recommendation module 17 shows one or more shots having a highest relational index with the advertisement, or one or more shots having a relational index greater than a threshold with the advertisement (step S66).

For example, if a first video is divided into three shots and a second video is divided into five shots, the recommendation module 17 compares and calculates the inputted advertisement with each shot of the first video and the second video to obtain eight relational indexes for the advertisement, wherein each of the eight relational indexes represents a relation between the advertisement and each of the eight shots.

By taking advantages of the technical solutions of the FIG. 9, the identification system 1 of the invention and the identification method thereof facilitate a sponsor of an advertisement to find a place that is the most appropriate for the publication of the advertisement. Thus, effectiveness of the advertisement can be greatly improved.

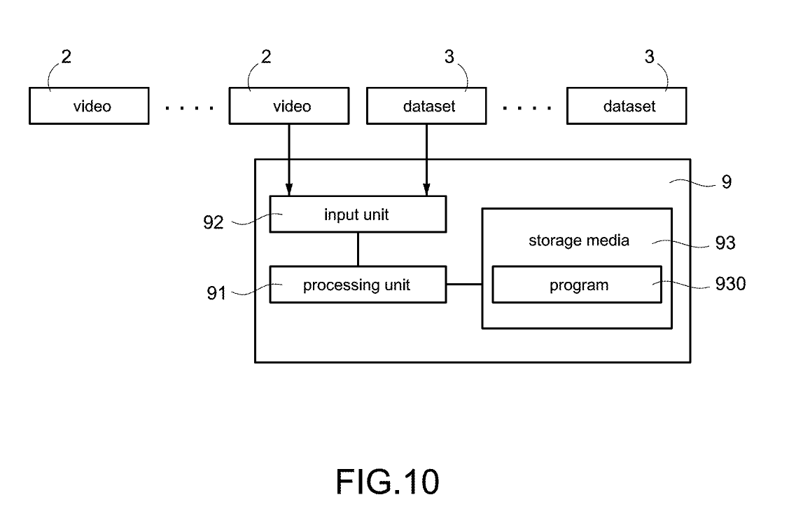

Referring to FIG. 10, FIG. 10 is a block diagram of an identification system according to a second preferred embodiment of the invention. In the embodiment, another identification system 9 is provided. The identification system 9 is implemented as a local terminal, an electronic apparatus, a mobile communication device, or a cloud server and is not limited thereto.

As shown in FIG. 10, the identification system 9 includes a processing unit 91, an input unit 92 and a storage media 93 whereas the processing unit 91 is electrically connected to each of the input unit 92 and the storage media 93, and the storage media 93 is a non-volatile storage media (or a non-transitory storage).

In the embodiment, the input unit 92 receives a plurality of videos 2 for identifying them. And in turn, the abovementioned descriptor lists 5 and the content lists 4 are created and updated. Also, the input unit 92 receives a plurality of datasets 3 for training the abovementioned DSM 120. In the embodiment, the descriptor lists 5, the content lists 4 and the DSM 120 are stored in the storage media 93 and are not limited thereto.

In the embodiment, the storage media 93 stores a program 930 which has machine codes or program codes executable by the processing unit 91. After the program 930 is run by the processing unit 91, the identification system 9 of the invention performs the following tasks to execute the identification method of the invention: providing a video 2; converting content of the video 2 into a content list 4; providing the DSM 120; importing a descriptor list 5 of the content list 4 into the DSM 120; fetching a plurality of inferred descriptors 73 having a relation with a plurality of raw descriptors 71 from a plurality of node descriptors 61 of the DSM 120; refining the raw descriptors 71 based on a plurality of directed edges 62 in the DSM 120 corresponding to the raw descriptors 71 so as to convert the raw descriptors 71 into a plurality of refined descriptors 72; and updating the descriptor list 5 based on the inferred descriptors 73 and the refined descriptors 72.

By utilizing the identification systems 1 and 9 of the invention and the identification method thereof, it is capable of identifying both significant features and extension messages presented of the video. As a result, content of each shot of the video can be described correctly.

While the invention has been described in terms of preferred embodiments, those skilled in the art will recognize that the invention can be practiced with modifications within the spirit and scope of the appended claims.

What is claimed is:

1. A method for identifying extension messages of video, comprising the steps of:
(a) providing a video;
(b) converting content of the video into a content list including a plurality of descriptor lists, each of the descriptor lists recording a time interval and a raw descriptor for describing a feature presented in the video at the time interval;
(c) providing a descriptor semantic model (DSM) including a plurality of node descriptors and a plurality of directed edges, wherein each node descriptor corresponds to a predetermined feature, and the directed edges define relation strengths among the node descriptors;
(d) importing one of the descriptor lists of the content list into the DSM, wherein the node descriptors include the raw descriptors;
(e) fetching an inferred descriptor inferred from the node descriptors following step (d), the inferred descriptor having a relation with the raw descriptors; and
(f) adding the inferred descriptor to the imported descriptor list to update the descriptor list.

2. The method of claim 1, wherein step (e) further involves calculating a relational index of the raw descriptors with other node descriptors based on the directed edges, and taking one or more node descriptors having a highest relational index as at least one inferred descriptor, or taking one or more node descriptors having a relational index greater than a threshold value as the at least one inferred descriptor.

3. The method of claim 1, further comprising the sub-steps of:
(e1) after step (d), refining the raw descriptors based on the directed edges corresponding to the raw descriptors in the DSM for converting the raw descriptors into a plurality of refined descriptors, wherein a number of the refined descriptors is equal to or less than a number of the raw descriptors; and
(f1) updating the raw descriptors in the imported descriptor list based on the refined descriptors.

4. The method of claim 3, wherein step (e1) further involves calculating a relational index among the raw descriptors based on the directed edges, and taking one or more raw descriptors having a highest relational index as at lease one refined descriptor, or taking one or more raw descriptors having a relational index greater than a threshold value as the at least one refined descriptor.

5. The method of claim 3, wherein step (e) further involves fetching the inferred descriptors related to the refined descriptors from the node descriptors, and step (e1) further involves refining the raw descriptors based on the directed edges corresponding to the raw descriptors and the inferred descriptors in the DSM.

6. The method of claim 1, further comprising the steps of:
(g) determining whether the video has been identified;
(h) before finishing the video identification, importing next descriptor list of the content list into the DSM and returning to steps (e) and (f); and
(i) after finishing the video identification, outputting the updated descriptor lists.

7. The method of claim 1, wherein step (b) further comprises the sub-steps of:
(b1) dividing the video into a plurality of shots;
(b2) analyzing one of the shots for identifying a plurality of features presented in the shot;
(b3) creating a plurality of raw descriptors corresponding to the identified features;
(b4) creating a descriptor list based on the raw descriptors and a time interval corresponding to the shot;
(b5) repeatedly performing steps (b2) to (b4) before finishing the analysis of the plurality of shots; and
(b6) creating a content list based on the descriptor lists after finishing the analysis of the plurality of shots.

8. The method of claim 7, wherein the dividing of step (b1) is performed based on a predetermined time interval, scene change, or frame.

9. The method of claim 1, further comprising the steps of:
(j1) selecting one of a plurality of videos;
(j2) comparing the content list of the selected video with criteria of multiple advertisement categories;
(j3) calculating a relational index of each shot of the video with each advertisement category; and
(j4) showing one or more advertisement categories having a highest relational index with each shot of the video, or showing one or more advertisement categories having a relational index greater than a threshold with each shot of the video.

10. The method of claim 1, further comprising the steps of:
(k1) inputting criteria of an advertisement;
(k2) comparing the criteria with the content lists of multiple videos;
(k3) calculating a relational index of each shot of each video with the advertisement; and
(k4) showing one or more shots having a highest relational index with the advertisement, or showing one or more shots having a relational index greater than a threshold with the advertisement.

11. A system for identifying extension messages of video, comprising:
a video conversion module for selecting a video and converting content of the selected video into a content list, wherein the content list includes a plurality of descriptor lists, each descriptor list recording a time interval and a raw descriptor for describing a feature of the video presented in the time interval;
a descriptor relation learning module for training and creating a descriptor semantic model (DSM) by using a plurality of datasets, wherein the DSM includes a plurality of node descriptors corresponding to a plurality of predetermined features respectively, and a plurality of directed edges, each defining a relational strength between two of the node descriptors; and
an inference module for importing one of the descriptor lists of the content list into the DSM, wherein the node descriptors include the raw descriptors, the inference module obtains an inferred descriptor related to the raw descriptors from the node descriptors, and the inference module adds the inferred descriptor to the imported descriptor list for updating the descriptor list.

12. The system of claim 11, further comprising a data collection module for accessing the Internet to collect public data for the plurality of datasets, wherein the data collection module inputs the datasets to the descriptor relation learning module to train the DSM.

13. The system of claim 11, wherein the inference module calculates a relational index of the raw descriptors with other node descriptors based on the directed edges, and takes one or more node descriptors having a highest relational index as at least one inferred descriptor, or takes one or more node descriptors having a relational index greater than a threshold value as the at least one inferred descriptor.

14. The system of claim 11, further comprising a refinement module for refining the raw descriptors based on the directed edges corresponding to the raw descriptors in the DSM for converting the raw descriptors into a plurality of refined descriptors, and updating the raw descriptors in the imported descriptor list based on the refined descriptors, wherein a number of the refined descriptors is equal to or less than that of the raw descriptors.

15. The system of claim 14, wherein the refinement module calculates a relational index among the raw descriptors based on the directed edges, and takes one or more raw descriptors having a highest relational index as at least one refined descriptor, or takes one or more raw descriptors having a relational index greater than a threshold value as the at least one refined descriptor.

16. The system of claim 14, wherein the inference module fetches the inferred descriptor related to the refined descriptors from the node descriptors, and the refinement module refines the raw descriptors based on the directed edges corresponding to the raw descriptors and the inferred descriptors in the DSM.

17. The system of claim 11, wherein the video conversion module divides the video into a plurality of shots, analyzes each of the shots for identifying a plurality of features respectively presented in each shot, creates a plurality of raw descriptors corresponding to the features respectively presented in each shot, creates respectively a descriptor list based on the raw descriptors and a time interval corresponding to each shot, and creates a content list based on the descriptor lists of the shots after finishing the analysis of the shots.

18. The system of claim 11, further comprising an analysis module for comparing the content list of the video with criteria of multiple advertisement categories, calculating a relational index of each shot of the video with each of the advertisement categories, and showing one or more advertisement categories having a highest relational index with each shot of the video, or showing one or more advertisement categories having a relational index greater than a threshold with each shot of the video.

19. The system of claim 11, further comprising a recommendation module for comparing criteria of an advertisement with the content lists of multiple videos, calculating a relational index of each shot of each video with the advertisement, and showing one or more shots having a highest relational index with the advertisement, or showing one or more shots having a relational index greater than a threshold with the advertisement.

20. A non-transitory storage media for storing a program which, when executed by a processing unit, performs operations comprising:
providing a video;
converting content of the video into a content list including a plurality of descriptor lists, each descriptor list recording a time interval and a raw descriptor for describing a feature presented in the video at the time interval;
providing a descriptor semantic model (DSM) including a plurality of node descriptors and a plurality of directed edges, wherein each node descriptor corresponds to a predetermined feature, and the directed edges define relation strengths among the node descriptors;
inputting one of the pluralities of descriptor lists of the content list into the DSM, wherein the node descriptors include the raw descriptors;
fetching an inferred descriptor from the node descriptors, the inferred descriptor having a relation with the raw descriptors;
refining the raw descriptors based on the directed edges corresponding to the raw descriptors in the DSM for converting the raw descriptors into a plurality of refined descriptors, wherein a number of the refined descriptors is equal to or less than that of the raw descriptors; and
updating the descriptor list based on the inferred descriptors and the refined descriptors.
